(19) United States
(12) Patent Application Publication
(10) Pub. No.: US 2016/0307169 A1
(43) Pub. Date: Oct. 20, 2016

(54) SYSTEM AND METHOD FOR RECYCLING TIRES INCLUDING TIRE PYROLYSIS

(71) Applicant: BRIDGESTONE AMERICAS TIRE OPERATIONS, LLC, Nashville, TN (US)

(72) Inventors: David G. Abdallah, JR., Nolensville, TN (US); John G. Sheerin, Oak Lawn, IL (US)

(21) Appl. No.: 15/103,480

(22) PCT Filed: Dec. 10, 2014
(86) PCT No.: PCT/US14/69430

§ 371 Date: Jun. 10, 2016

Related U.S. Application Data
(60) Provisional application No. 61/918,038, filed on Dec. 19, 2013.

(51) Int. Cl. G06Q 10/00; G06Q 20/10; G06Q 30/02; B29B 17/04; B29D 30/00

(52) U.S. Cl. CPC G06Q 10/30; B29B 17/04; B29D 30/0016; G06Q 30/0222; G06Q 20/10

(57) ABSTRACT

A shredded tire credit is used in methods and systems for recycling tires to enhance the efficiency of tire recycling sites distributed over large areas. A scrap tire delivery is sent to a scrap tire processor at a first shred facility for conversion into shredded tire product. A shredded tire credit is received from the scrap tire processor in return for the scrap tire delivery. The shredded tire credit is redeemed with the scrap tire processor for an amount of shredded tire product processed at a second shred facility of the scrap tire processor and delivered to a pyrolytic processor to generate at least one pyrolytic end product from the shredded tire product. A pyrolytic processor payment (including a pyrolytic end product or a secondary product derived therefrom) is received from the pyrolytic processor in return for the shredded tire product received from the redeemed shredded tire credit.

### TECHNICAL FIELD

This patent disclosure relates generally to tire recycling and, more particularly, to a system and a method for recycling tires which includes tire pyrolysis.

### BACKGROUND

When a rubber tire has reached the end of its useful life, it is highly desirable to recycle the raw materials found in the scrap tire. Scrap tires can be recycled to make many products, ranging from roads to sandals, for example. Scrap tires which are no longer suitable for use on vehicles as a result of excessive tread wear or irreparable damage, e.g., certain punctures, can be converted into new products and support a number of jobs in the rubber recycling industry. Recycling scrap tires also avoids discarding them in landfills.

A pyrolysis method for recycling scrap tires is a technique in which shredded tires are placed in a reactor vessel containing an oxygen-free atmosphere and a heat source. In the reactor, the rubber is softened so that the rubber polymers continuously break down into smaller molecules that eventually vaporize. These vapors can be burned directly to produce power, or condensed into an oily-type liquid, generally used as a fuel. The tire pyrolysis process is typically an environmentally “green” operation which produces substantially no emissions or waste.

Transportation costs associated with sending scrap tires from a collection site to a pyrolysis processor are a significant component of the total cost in recycling rubber tires. The costs associated with transporting the scrap tires over extended distances can negatively impact the economic viability of processing the scrap tires.

As a result, the tire recycling business has become a regional industry, making it difficult to serve the needs of national businesses seeking to utilize the recycled materials in regions geographically separated from the scrap tire collection sites. Consequently, there has been a long-standing need in the art to improve the manner in which scrap tires are recycled and the manner in which end products of tire recycling are made available to customers.

### SUMMARY OF THE DISCLOSURE

In one embodiment, a method for recycling tires is described. A scrap tire delivery is sent to a scrap tire processor at a first shred facility for conversion into shredded tire product. A shredded tire credit is received from the scrap tire processor in return for the scrap tire delivery. The shredded tire credit is redeemed with the scrap tire processor for an amount of shredded tire product processed at a second shred facility of the scrap tire processor and delivered to a pyrolytic processor to generate at least one pyrolytic end product from the shredded tire product. A pyrolytic processor payment is received from the pyrolytic processor in return for the shredded tire product received from the redeemed shredded tire credit. The pyrolytic processor payment includes an amount of at least one of: (i) a pyrolytic end product from the shredded tire product and (ii) a secondary product derived from a pyrolytic end product from the shredded tire product.

In another embodiment, a system for recycling tires is described. A physical computer-readable medium is provided which has computer-executable instructions stored thereon. The computer-executable instructions comprise a scrap tire credit and redemption program including a scrap tire credit module and a credit redemption module. A computer processor is adapted to execute the scrap tire credit and redemption program contained on the physical computer-readable medium. A network-enabled interface is operably arranged with the computer processor. The network-enabled interface is adapted to exchange information with a partner site over a network.

The scrap tire credit module has computer executable instructions adapted to calculate a value of a shredded tire credit based upon a scrap tire delivery by a scrap tire collector to a first shred facility of a scrap tire processor. The credit redemption module has computer executable instructions adapted to generate and send a redemption communication through the network to the scrap tire processor to redeem a selected shredded tire credit held by the scrap tire collector. The redemption communication includes information sufficient to indicate: the shredded tire credit being redeemed, an identification of a second shred facility of the scrap tire processor from which a specified quantity of shredded tire product is to be provided, and delivery information for a partner pyrolytic processor to which the shredded tire product is to be delivered.

In still another embodiment, a method for recycling tires is described. A computer processor is employed to execute computer-executable instructions of a scrap tire credit and redemption program stored on a physical computer-readable medium. The computer-executable instructions perform calculating and generating steps. A value of a shredded tire credit is calculated based upon a scrap tire delivery by a scrap tire collector to a first shred facility of a scrap tire processor. A redemption communication is generated which includes information sufficient to indicate: the shredded tire credit being redeemed, an identification of a second shred facility of the scrap tire processor from which a specified quantity of shredded tire product is to be provided, and delivery information for a partner pyrolytic processor to which the shredded tire product is to be delivered. The redemption communication is transmitted through a network including a web-enabled interface to the scrap tire processor.

Further and alternative aspects and features of the disclosed principles will be appreciated from the following detailed description and the accompanying drawings. As will be appreciated, the principles related to systems and methods for tire recycling disclosed herein are capable of being carried out in other and different embodiments, and capable of being modified in various respects. Accordingly, it is to be understood that the foregoing general description and the following detailed description is exemplary and explanatory only and does not restrict the scope of the disclosed principles.

### BRIEF DESCRIPTION OF THE SEVERAL VIEWS OF THE DRAWINGS

FIG. 1 is a schematic view of an embodiment of a system for tire recycling in accordance with principles of the present disclosure.

FIG. 2 is a schematic block diagram of an embodiment of a scrap tire pyrolysis system suitable for use in systems and methods for tire recycling in accordance with principles of the present disclosure.

FIG. 3 is a flowchart illustrating steps of an embodiment of a process for tire recycling in accordance with principles of the present disclosure.

FIG. 4 is a flowchart illustrating steps of an embodiment of a process for tire recycling in accordance with principles of the present disclosure.

FIG. 5 is a schematic diagram of an embodiment of a computer-implemented system in accordance with principles of the present disclosure.

### DETAILED DESCRIPTION OF PREFERRED EMBODIMENTS

The present disclosure is directed to embodiments of systems and methods for tire recycling and tangible computer-readable media containing programs suitable for use in tire recycling contexts. In embodiments, systems and methods for recycling tires include a shredded tire credit issuance and redemption technique to facilitate the recycling process. Embodiments of methods and systems for tire recycling following principles of the present disclosure can reduce transportation costs associated with the recycling of scrap tires.

In embodiments, a scrap tire collector can send a scrap tire delivery to a scrap tire processor at a first shred facility in exchange for receiving a shredded tire credit from the scrap tire processor. The scrap tire processor can shred the scrap tire delivery at the first shred facility to convert the scrap tire(s) received from the scrap tire collector into shredded tire product. The scrap tire processor can sell the shredded tire product in a regional market of the first shred facility.

The scrap tire collector can redeem the shredded tire credit issued by the scrap tire processor for an amount of shredded tire product processed at a second shred facility of the scrap tire processor. In embodiments, the second shred facility can be located in a different region which is relatively far away from the location of the scrap tire collector (e.g., greater than a predetermined distance for economically transporting scrap tires, such as, greater than two hundred (200) miles). The shredded tire product processed at the second shred facility of the scrap tire processor can be delivered to a partner pyrolytic processor to generate at least one pyrolytic end product from the shredded tire product. In embodiments, the pyrolytic processor is located closer to the second shred facility than to the first shred facility.

The scrap tire collector can receive a pyrolytic processor payment from the pyrolytic processor in return for the shredded tire product received from the redeemed shredded tire credit. The pyrolytic processor payment can include an amount of a pyrolytic end product from the shredded tire product and/or a secondary product derived from a pyrolytic end product, such as electricity produced by a generator powered by a pyro-gas, for example.

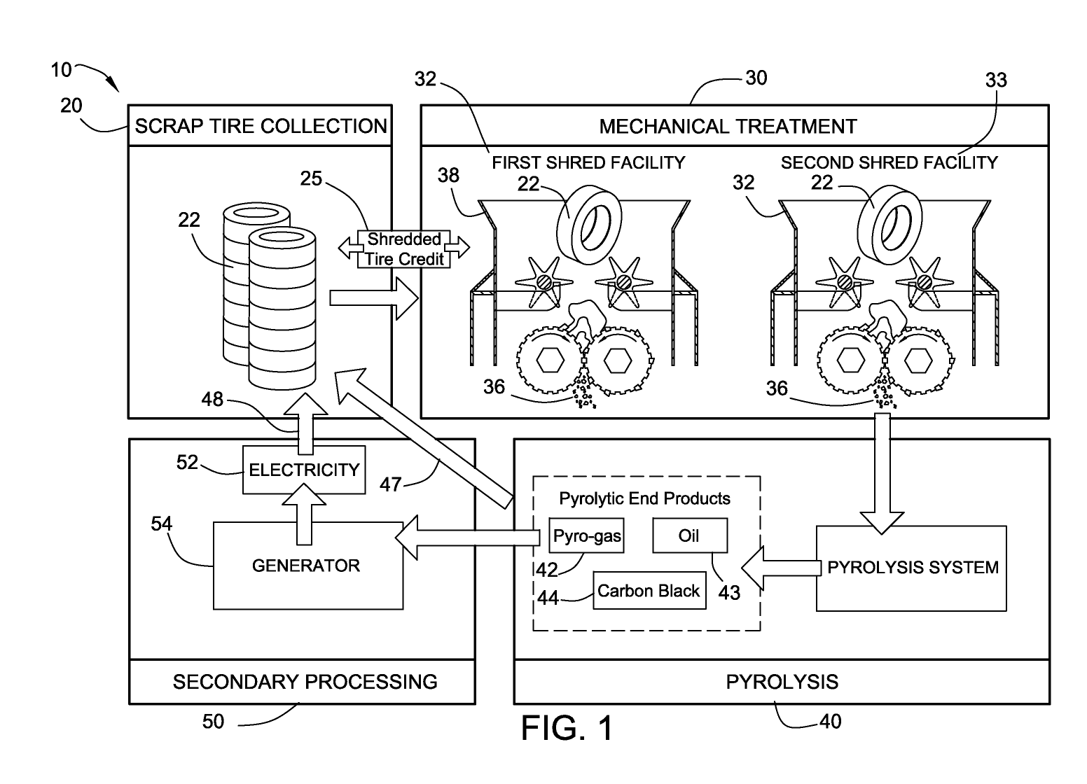

Turning now to the Figures, there is shown in FIG. 1 a block diagram illustrating an embodiment of a tire recycling system 10 in accordance with principles of the present disclosure. The tire recycling system 10 includes a scrap tire collection and delivery system 20, a mechanical treatment system 30, a pyrolysis system 40, and a secondary processing system 50.

The scrap tire collection and delivery system 20 can include any suitable equipment configured to intake and store scrap tires 22 and to transport one or more scrap tire deliveries to a scrap tire processor operating the mechanical treatment system 30. The scrap tire delivery system 20 can be adapted to send a scrap tire delivery to a scrap tire processor at a first shred facility 32 for conversion into shredded tire product. In embodiments, the scrap tire collector receives a shredded tire credit 25 from the scrap tire processor in return for the scrap tire delivery made to the first shred facility 32.

In embodiments, the scrap tires 22 can be any type of old or new tires, including steel belted radials, car, truck and other motor vehicle tires, whether in the form of whole tires or tire pieces. In embodiments, at least one scrap tire 22 comprises a tire used for commercial machines, such as those used in the mining industry.

In embodiments, the scrap tire collection and delivery system 20 can include a storage facility configured to house an inventory of scrap tires 22 until the scrap tires 22 are transported to the scrap tire processor operating the mechanical treatment system 30. In embodiments, the storage facility can be located at the site of a scrap tire generator (e.g., a tire end-user) or can be located remotely and used to store scrap tires 22 from one or more scrap tire generators.

For example, in one embodiment, a scrap tire storage facility can be located at a tire retread site. The tire retreader can store scrap tires 22 (e.g., tires which cannot be retread because they have irreparable punctures) in the scrap tire storage facility. At periodic intervals, the tire retreader can arrange for a scrap tire delivery to a first shred facility of the mechanical treatment system 30 operated by a partner scrap tire processor.

In embodiments, the scrap tire collection and delivery system 20 can include one or more vehicles configured to transport a load of scrap tires 22 to the first shred facility 32 of the mechanical treatment system 30. In embodiments, the vehicle comprises a truck. In embodiments, the scrap tire collector can collect at least one scrap tire from a site of a scrap tire generator for inclusion in a scrap tire delivery to the scrap tire processor at the first shred facility 32.

In embodiments, the scrap tire delivery system 20 can include portable shear equipment adapted to break down the scrap tires 22 before delivery to the first shred facility 32. The portable shear equipment can be used, for example, to break down the scrap tires 22 into tire fragments before transporting them to avoid using an over-sized vehicle which may be necessary to accommodate a very large scrap tire and/or a scrap tire delivery including numerous scrap tires 22. In embodiments, any suitable portable shear equipment which is configured to convert scrap tires 22 into smaller tire fragments can be used.

A scrap tire processor can operate the mechanical treatment system 30 to process the scrap tires to ready the scrap tires for the pyrolysis process. In embodiments, the mechanical treatment system 30 can include at least two shred facilities 32, 33. Each shred facility 32, 33 can be configured to process scrap tires by shredding the scrap tires into smaller pieces to produce shredded tire product 35, 36.

The first shred facility 32 is separate and distinct from the second shred facility 33. In embodiments, the first shred facility 32 can be geographically separated from the second shred facility 33 by a distance greater than a predetermined minimum distance. In embodiments, the first shred facility 32 can be geographically separated from the second shred facility 33 by a distance greater than a predetermined distance for economically transporting scrap tires, such as, greater than two hundred (200) miles, for example.

In embodiments, each shred facility 32, 33 of the mechanical treatment system 30 can include any suitable shredding equipment 38 adapted to mechanically break down the scrap tires 22 into shredded tire product 35, 36. Exemplary shredding equipment which can be used in embodiments following principles of the present disclosure include those that are commercially available (e.g., those available from Granutech-Saturn Systems of Grand Prairie, Tex., such as the Saturn Model 73-46 tire shredder) and those shown and described in U.S. Patent Application No. US 2006/0118671 (“Tire Size Reduction/Wire Separation System”) and U.S. Patent Application No. US 2005/0205701 (“Krumbuster 4X”). In the illustrated embodiment, the shredding equipment 38 at the first and second shred facilities 32, 33 is substantially similar. In other embodiments, the shredding equipment at the second shred facility 33 can be different from that installed in the first shred facility 32.

In embodiments, the scrap tires 22 in the scrap tire delivery made by the scrap tire collector to the first shred facility 33 can be mechanically treated at the first shredding facility 32 to convert the scrap tires 22 into shredded tire product 35. In embodiments, the shredded tire product 35 can be dimensioned and otherwise configured for use in either pyrolysis or non-pyrolysis recycling applications. The scrap tire processor can sell the shredded tire product 35 in the regional market of the first shred facility 32.

The scrap tire collector can redeem the shredded tire credit 25 for shredded tire product 36 made from different scrap tires 39 located at the second shred facility 33 of the scrap tire processor. In embodiments, the shredded tire product 36 can be less than a predetermined shred size (such as, less than about two inches in longest dimension, for example) and/or can have an average size within a predetermined range suitable for use in the pyrolysis system 40.

In embodiments, the shredded tire product 36 leaving the tire shredder 38 of the second shred facility 33 can be fed through a screening mechanism. Oversized pieces trapped by the screening mechanism can be returned to the tire shredder 38. The shredded tire product 36 that passes through the screening mechanism can be subjected to a magnetic mechanism, such as a magnetic head pulley, for example, to remove bulk amounts of steel mesh. In other embodiments, any suitable magnetic separators can be used. The steel removed from the shredded tire product 36 can be subjected to further steel processing or recovery for uses such as steel reinforcing wire and the like in accordance with steel refining methods known in the art.

An amount of the shredded tire product 36 corresponding to the value of the redeemed shredded tire credit 25 can be produced at the second shred facility 33 and transported to a partner pyrolysis processor operating the pyrolysis system 40. In embodiments, the second shred facility 33 is located closer to the site of the pyrolysis system 40 than the first shred facility 32. In embodiments, the second shred facility 33 is located within a predetermined distance from the site of the pyrolysis system 40.

The pyrolysis system 40 can be adapted to process the shredded tire product 36 into at least one type of pyrolytic end product 42, 43, 44. In embodiments of systems and methods for tire recycling following principles of the present disclosure, any suitable tire pyrolysis system 40 can be used to convert the shredded tire product 36 into at least one pyrolytic end product selected from the group comprising pyro-gas 42, oil 43, and carbon black 44.

In embodiments, the pyrolysis system 40 is used to convert the shredded tire product 36 received from the second shred facility 33 in exchange for the redeemed shredded tire credit 25 into at least one pyrolytic end product 42, 43, 44. In embodiments, the pyrolysis system 40 of the partner pyrolytic processor is located closer to the second shred facility 33 than to the first shred facility 32.

In embodiments, the pyrolysis system 40 comprises a continuous, semi-continuous, or batch scrap tire pyrolysis system adapted to be used to process scrap tires into pyrolytic end products 42, 43, 44. Exemplary tire pyrolysis systems 40 which can be used in embodiments following principles of the present disclosure are shown and described in U.S. Patent Application Publication Nos. US 200/0119089 (“Process for Pyrolyzing Tire Shreds and Tire Pyrolysis Systems”); US 2009/0200150 (“Waste-Tire Recycling System”); and US 2011/0200518 (“Method of Reclaiming Carbonaceous Materials From Scrap Tires and Products Derived Therefrom”).

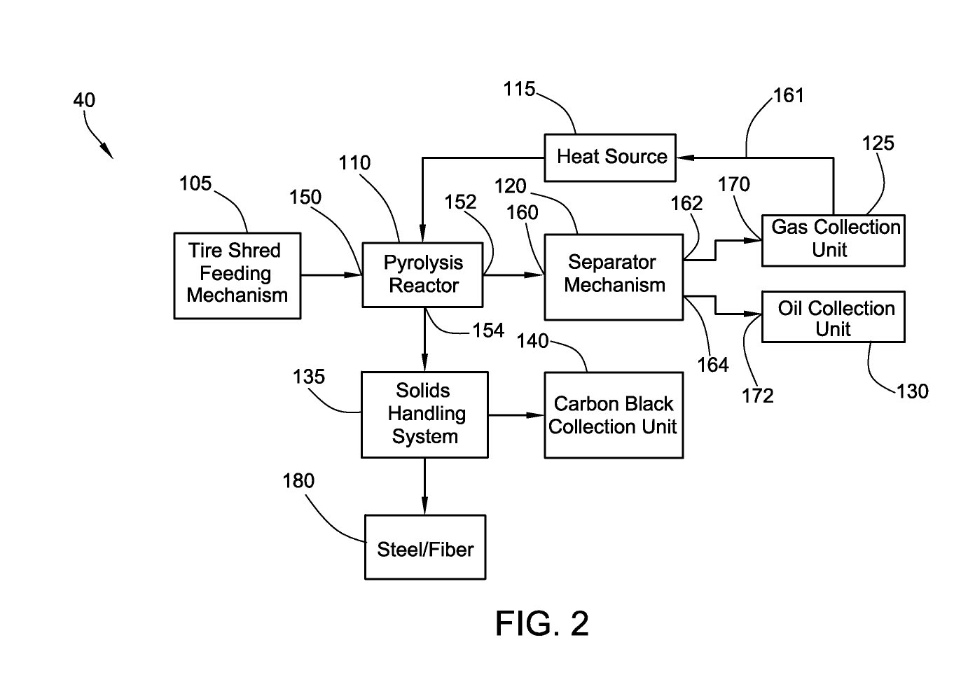

Referring to FIG. 2, an illustrative embodiment of a scrap tire pyrolysis system 40 includes a tire shred feeding mechanism 105, a pyrolysis reactor 110, a heat source 115 in heat transferring relationship to the pyrolysis reactor 110, a separation mechanism 120 in fluid communication with the pyrolysis reactor 110, a gas collection unit 125 and an oil collection unit 130 both in fluid communication with the separation mechanism 120, a solids handling system 135 in communication with the pyrolysis reactor 110, and a carbon black collection unit 140 operably arranged with the solids handling system 135. The tire shred feeding mechanism 105 can be in communication with a tire shred inlet 150 of the pyrolysis reactor 110 and can be adapted to selectively feed the shredded tire product 36 to the pyrolysis reactor 110. The pyrolysis reactor 110 can be adapted to convert the shredded tire product 36 into a solid state (raw carbon black and steel wire) and a gas state (pyro-gas). The pyrolysis reactor 110 can include a gas stream outlet 152 in fluid communication with the separator mechanism 120 which can be adapted to facilitate the condensation of the gas stream flowing therethrough. The pyrolysis reactor can also include a solids outlet 154 in communication with the solids handling system 135. Carbon-containing solids can be discharged from the pyrolysis reactor 110 out the solids outlet 154 to the solids handling system 135. The solids handling system 135 can be adapted to convert at least some of the carbon-containing solids to finished carbon black.

In embodiments, the tire shred feeding mechanism 105 can comprise any suitable equipment adapted to feed acceptably-sized shredded tire product 36 into the pyrolysis reactor 110. In embodiments, the tire shred feeding mechanism 105 can be adapted to send the shredded tire product 36 and a catalyst together into the pyrolysis reactor 110. In embodiments, any suitable feeding mechanism 105, such as a continuous feeding mechanism, for example, can be used. In an exemplary embodiment, the feeding mechanism 105 includes a conveyor belt or other similar device and a weight controller for metering the amount of the shredded tire product 36 fed into the pyrolysis reactor 110.

The shredded tire product 36 can be fed into the pyrolysis reactor 110 through the tire shred inlet 150 of the reactor 110. The pyrolysis reactor 110 can be any suitable reactor vessel configured to pyrolyze shredded tire product 36. In embodiments, the pyrolysis reactor 110 can be a continuous or batch pyrolysis reactor.

The operating pressure within the pyrolysis reactor 110 can be below atmospheric pressure to provide a slight vacuum pressure within the reactor 110, which can be substantially sealed such that the reactor 110 is substantially, and preferably virtually completely, anaerobic in operation. The rate of travel of the shredded tire product 36 through the reactor 110 can be varied to provide a desired residence time for the shredded tire product 36 within the reactor 110. The feed rate and timing of entry of the shredded tire product 36 into the pyrolysis reactor 110 can be controlled by at least one, and preferably several, timed feed airlocks which are operated by a control mechanism, including mechanical drives or solenoid driven mechanisms, for example. In addition, the temperature inside the pyrolysis reactor 110 can be controlled to provide a desired pyrolysis reaction.

The heating system 115 can be adapted to provide the material inside the pyrolysis reactor 110 with an adequate heat for low-temperature pyrolysis and cracking reactions. In embodiments, at least one heating element can be in heat exchange relation with the pyrolysis reactor 110. Pyrolytic processing of the shredded tire product 36 can occur in the pyrolysis reactor 110 under highly-controlled conditions that reduce or eliminate oxygen to promote the thermal decomposition of the organic material in the shredded tire product 36 without combustion. In embodiments, a catalyst can be used to accelerate the decomposition.

Any suitable energy source can be used to drive the decomposition of the rubber, including using direct-fired fuel (e.g., a gas oven) or electrical induction (e.g., an electrically-heated oven), for example. In embodiments, heat can be provided using any suitable source, such as, hydrocarbon or natural fuel (gas, coal, wood), electric heat, hot flue gas from a high-temperature incinerator or other suitable heating source, for example. In embodiments, the gas used to provide heat in the burner(s) is taken from a flow 161 of gas that remains uncondensed after passing through a gas stream outlet 162 of the separation mechanism 120.

The shredded tire product 36 within the reactor 110 is pyrolyzed, thereby resulting in formation of pyrolysis gases and solids. The pyrolysis reaction within the reactor 110 breaks down complex molecules in the shredded tire product 36 into simpler molecules using indirect heat from the heat source 115. The smaller molecules can eventually vaporize and exit from the reactor 110 through the gas stream outlet 152. The pyrolysis gas leaving the reactor 110 can comprise hydrocarbons, particulate and oil vapor. The solids can be discharged from the solids outlet 154 and can comprise carbon, as well as steel and fiber from the shredded tire product 36. In embodiments, the solids outlet 154 can be disposed at one end of a screw or other continuous mechanism of the solids handling system 135 and/or at the bottom of the reactor 110 in a gravity-fed system.

The pyro-gas exiting the reactor 110 through the gas stream outlet 152 can be burned as a fuel directly or condensed into an oily-type liquid, generally used as a fuel. The separation mechanism 120 can be provided to condense the oil entrained in the pyro-gas. The separation mechanism 120 can include a separator unit, a cooling system, and a gas scrubbing system. The cooling system can be provided to cool down the pyro-gas into either liquid oil or combustible gas. The combustible gas scrubbing system can be provided to scrub the combustible gas with a clarifying solution to eliminate contaminants.

In embodiments, an inlet 160 of the separator unit 120 can be in fluid communication with the gas stream outlet 152 of the pyrolysis reactor 110. The gas stream can be discharged from the reactor 110 out the gas stream outlet 152 to the inlet 160 of the separator unit 120.

In embodiments, the pyro-gas stream that enters the inlet 160 of the separator unit 120 can be treated with an oil spray from at least one oil sprayer. In embodiments, the number and arrangement of sprayers can be varied. In some embodiments, an array of sprayers is positioned across the separator unit 120 along an axis in transverse relationship to the direction of flow of the pyro-gas stream through the separator unit. In embodiments, the temperature of the oil spray from the oil sprayers is cooler than the temperature of the pyro-gas stream entering the separator unit 120 such that the oil spray promotes the condensation of at least a portion of the oil in the pyro-gas stream. In some embodiments, the separation mechanism 120 can include a separation unit coupled with a downstream condenser to further condense any non-condensed gas exiting the separation unit. In embodiments, the gas stream can be drawn through the separation mechanism 120 by using a pressure adjusting source, such as, a vacuum system, blower, or other suitable device, for example.

A non-condensed gas stream can exit the separation mechanism 120 through the gas outlet 162 which is in fluid communication with an inlet 170 of the gas collection unit 125. Non-condensed gases—which can include gases such as methane, hydrogen and propane—can be further fractionated by any gas fractionation method known to those of ordinary skill in the art. In embodiments, a portion of the pyro-gas in the gas collection unit 125 can be used as fuel for generating heat for the heating source 115 for the pyrolysis reactor 110.

The oil condensed from the gas stream passing through the separation mechanism 120 can be discharged from a liquid outlet 164, which is in fluid communication with an inlet 172 of the oil collection unit 130. In embodiments, the oil collection unit can be any suitable storage vessel, such as a storage tank, for example.

In embodiments, the solids handling system 135 includes a raw carbon black processing system adapted to convert the solid products from the pyrolysis reactor 110 from raw carbon into finished carbon black. In embodiments, the solids handling mechanism 135 includes a cooling auger adapted to cool the solids discharged from the pyrolysis reactor 110 and convey the solids to the carbon black processing system.

The solids outlet 154 can be in communication with an inlet of the cooling auger through an interposed airlocks and airtight flexible compensator which is configured to allow the communication to be maintained through various position changes caused by thermal expansion and contraction of the reactor. The solids leaving the pyrolysis reactor 110 through the solids outlet 154 can be transported to the inlet of the cooling auger by any suitable technique, such as gravity-feed, conveyor, a tray system, an additional auger, or any other suitable solids conveyance mechanism. The cooling auger can be adapted to direct the solids for further separation in the carbon black processing system.

In embodiments, the auger can be pressurized with an inert gas in order to prevent combustion of the hot carbon. The inert gas can be provided by an inert gas source, such as, a nitrogen feed or cooled flue gas generated by burners burning purified pyrolysis gas, for example. In embodiments, the hot solids in the auger can be cooled by cooling water introduced to a cooling jacket in heat transferring relationship with the solids being conveyed by the auger.

Carbon black and other solids, such as steel and fiber, for example, can be discharged from an outlet of the auger into an inlet of a carbon black processing system. Steel and fiber 180 can be removed from the solids stream using any suitable technique, such as a vibratory separator, for example. In embodiments, a suitable magnetic separator can be provided downstream of the vibratory separator which further removes remaining metallic particulates, such as steel.

The remaining solid material, often referred to as “char,” can be recovered as carbon black. At least a portion of the solid material can be converted to carbon black in the raw carbon black processing system. In embodiments, any suitable raw carbon black processing system can be used. The finished carbon black can be stored in the carbon black collection unit 140.

Emissions from the pyrolysis process can be considerably lower than those produced by incinerating scrap tires. For example, in embodiments, up to about 99% of the material treated can be recovered with virtually no effluents escaping into the environment. In embodiments, no smokestack is necessary for the pyrolysis processing of scrap tires.

In an embodiment of a process for pyrolyzing shredded tire product, the shredded tire product 36 is fed to the pyrolysis reactor 110. After sufficient residence time for a particular heat and pressure profile, the shredded tire product 36 can be pyrolyzed within the reactor 110 to produce a hydrocarbon-containing gas stream and a carbon-containing solid. The hydrocarbon-containing gas stream can be discharged from the pyrolysis reactor 110 through the gas stream outlet 152 to the separation mechanism 120 to condense at least a portion of the gas stream into oil. The carbon-containing solid can be discharged from the pyrolysis reactor 110 through the solids outlet 154 and preferably directed to a cooling auger of the solids handling system 135.

The separation mechanism 120 can produce condensed oils and a non-condensed hydrocarbon-containing gas stream. In embodiments, the separation mechanism 120 can include at least one oil sprayer which is configured to receive a portion of the condensed oil from the separator after passing through a heat exchanger to cool the oil prior to spraying the hydrocarbon-containing gases passing through the separator.

The gas stream can be treated in the separation mechanism 120 with an oil spray to thereby wash particulate from the gas stream and to condense a portion of the gas stream to oil. Oils from the separator can be removed from the separator and collected in the oil collection unit 130 as products of the pyrolysis process. In embodiments, a portion of the oil in the separator is cooled and directed for use as oil spray in the separator.

The non-condensed gas can be discharged from the separation mechanism 120 and stored in the gas collection unit 125. The non-condensed gas can be collected for use as fuel. In embodiments, at least a portion of the remaining non-condensed gas from the gas stream is directed to at least one burner in heat exchange relation with the pyrolysis reactor 110 to provide a source of fuel.

Carbon-including solids can be discharged from the pyrolysis reactor 110 through the solids outlet 154 to the solids handling system 135. In embodiments, the solids discharged from the pyrolysis reactor 110 are directed to a carbon black processing system via a cooling auger for separating finished carbon black from the carbon-containing solids leaving the reactor 110.

The pressure within the auger can be greater than the pressure within the pyrolysis reactor, and in embodiments the pressure in the auger is maintained at greater than atmospheric pressure. The pressure within the carbon black separation system can be maintained at a pressure lower than the pressure in the cooling auger and higher than the pressure in the pyrolysis reactor. In embodiments, the pressure in the auger is maintained at greater than atmospheric pressure, the pressure in the pyrolysis reactor is maintained at less than atmospheric pressure, and the pressure in the carbon black handling system is in a range between the pressure in the pyrolysis reactor and in the auger.

Any suitable carbon black processing system known to those skilled in the art can be used. Solids can be directed through the process with reduced exposure to fumes from the hydrocarbon-containing pyrolysis gases leaving the pyrolysis reactor 110 and reduced exposure to oxygen.

Referring back to FIG. 1, in embodiments, the partner pyrolytic processor can send a pyrolytic payment 47, 48 to the scrap tire collector in return for the shredded tire product 36 the processor received from the second shred facility 33. In embodiments, the pyrolytic payment includes at least one pyrolytic end product 47, or at least one secondary product 48 derived from a pyrolytic end product, made from the shredded tire product 36. Exemplary pyrolytic end products 42, 43, 44 which can be produced by the pyrolysis system 40 from the shredded tire product 36 following principles of the present disclosure comprise pyro-gas 42, oil 43, and carbon black, for example. For example, in embodiments, the pyrolysis system 40 produces pyro-gases, oils/solvents, and carbon/carbonized materials from the shredded tire product 36. The carbonized material can be converted to carbon black for use in the production of new tires. In embodiments, metal cord can also be recovered from the shredded tire product 36.

In embodiments, at least one pyrolytic end product 42 is further used to generate a secondary product 52. Exemplary secondary products 52 which can be produced from pyrolytic end products produced in the pyrolysis system 40 from the shredded tire product 36 comprise energy (electrical energy, heat, cooling), steam, or hydrogen. In embodiments, the secondary product 52 of the pyrolytic processor payment 48 comprises electrical energy created by a generator 54 powered by pyro-gas 42 produced using the pyrolysis system 40. In embodiments, the secondary product 52 can be made by an entity different from the pyrolysis processor.

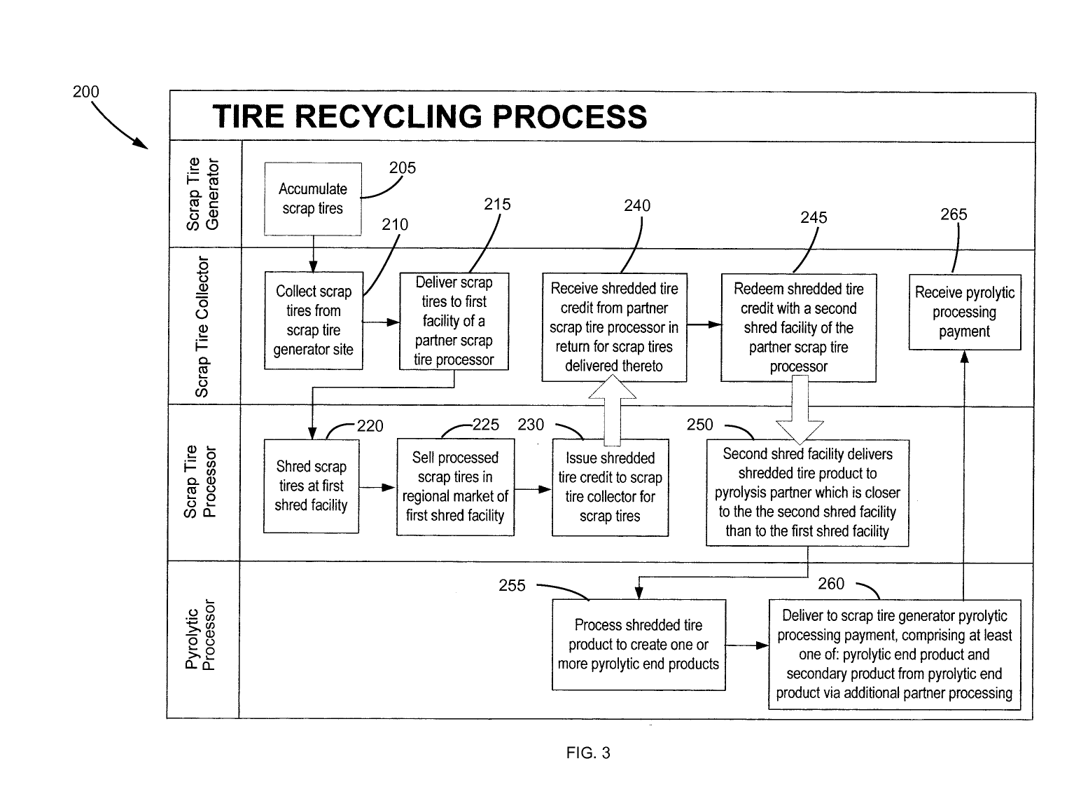

Referring to FIG. 3, a flow diagram is shown of steps of an embodiment of a process 200 for tire recycling following principles of the present disclosure. A scrap tire generator can accumulate scrap tires over time (step 205). In embodiments, the scrap tire generator comprises an end user of any suitable type of tire. In embodiments, the tire comprises an industrial-sized tire for a large machine, such as those used in the mining industry, for example.

A scrap tire collector can collect the scrap tire(s) from the scrap tire generator site (step 210). In embodiments, the scrap tire generator can deliver, or arrange for the delivery of, the scrap tires to the scrap tire collector. In embodiments, the scrap tire generator can be the same entity as the scrap tire collector.

The scrap tire collector can deliver the scrap tire(s) to a first shred facility of a scrap tire processor (step 215). In embodiments, the first shred facility is located within a predetermined distance from the starting point of the scrap tire delivery made by the scrap tire collector.

The scrap tire processor can shred the scrap tire(s) at the first shred facility to created shredded tire product (step 220). This shredded tire product can be sold in a regional market of the first shred facility (step 225). The scrap tire processor can issue a shredded tire credit to the scrap tire collector in return for the scrap tire(s) in the scrap tire delivery made by the scrap tire collector to the first shred facility (step 230).

The scrap tire collector receives the shredded tire credit from the scrap tire processor in return for the scrap tire(s) delivered to the scrap tire processor at the first shred facility (step 240). In embodiments, the value of the shredded tire credit can be based upon at least one of the following: the size/amount of the scrap tires in the scrap tire delivery, the amount of shredded tire product produced from the scrap tire(s) in the scrap tire delivery, and the amount of money received by the scrap tire processor from selling the shredded tire product produced from the scrap tire(s) in the scrap tire collector's scrap tire delivery.

The scrap tire collector can redeem the shredded tire credit at a second shred facility of the scrap tire processor (step 245). In embodiments, the second shred facility is located closer to a particular location than the first shred facility of the scrap tire processor. In embodiments, the second shred facility is located closer to a pyrolysis site of a pyrolytic processor than the first shred facility.

The scrap tire processor can make shredded tire product made at the second shred facility using different scrap tires than those in the scrap tire collector's scrap tire delivery made to the first shred facility. In embodiments, the scrap tires used to produce the shredded tire product at the second shred facility can be similar in type and/or constituent materials to those found in the scrap tire delivery made by the scrap tire collector to the first shred facility. An amount of the shredded tire product made at the second shred facility corresponding to the redeemed shredded tire credit can be delivered to a partner pyrolysis processor site which is closer to the second shred facility than to the first shred facility (step 250). In embodiments, the partner pyrolysis processor site is within a predetermined distance from the second shred facility.

The pyrolytic processor can process the shredded tire product received from the second shred facility to convert the shredded tire product into one or more pyrolytic end products (step 255). The pyrolytic processor can deliver a pyrolytic processor payment to the scrap tire collector in return for the shredded tire product received from the second shred facility (step 260). The pyrolytic processor payment can include at least one of a pyrolytic end product and a secondary product derived from a pyrolytic end product via additional processing.

The scrap tire collector can receive the pyrolytic processing payment (step 265) at any suitable location. In embodiments, the scrap tire collector can receive the pyrolytic processor payment to a site which is different than the site(s) of the scrap tire generator(s) from which the scrap tire(s) in the scrap tire delivery made to the first shred facility were collected and different from a site of the scrap tire collector from which the scrap tire delivery to the first shred facility began.

In embodiments, the pyrolytic processor payment can comprise a portion of the actual pyrolytic end product(s) made from the shredded tire product received from the second shred facility. In embodiments, the amount of the pyrolytic processor payment can be based upon at least one of the following: the amount of shredded tire product received by the pyrolytic processor from the second shred facility for the redeemed shredded tire credit, the amount of pyrolytic end product(s) produced from the shredded tire product received from the second shred facility, and the amount of money received by the pyrolytic processor from selling the pyrolytic end product(s) produced from the shredded tire product received from the second shred facility.

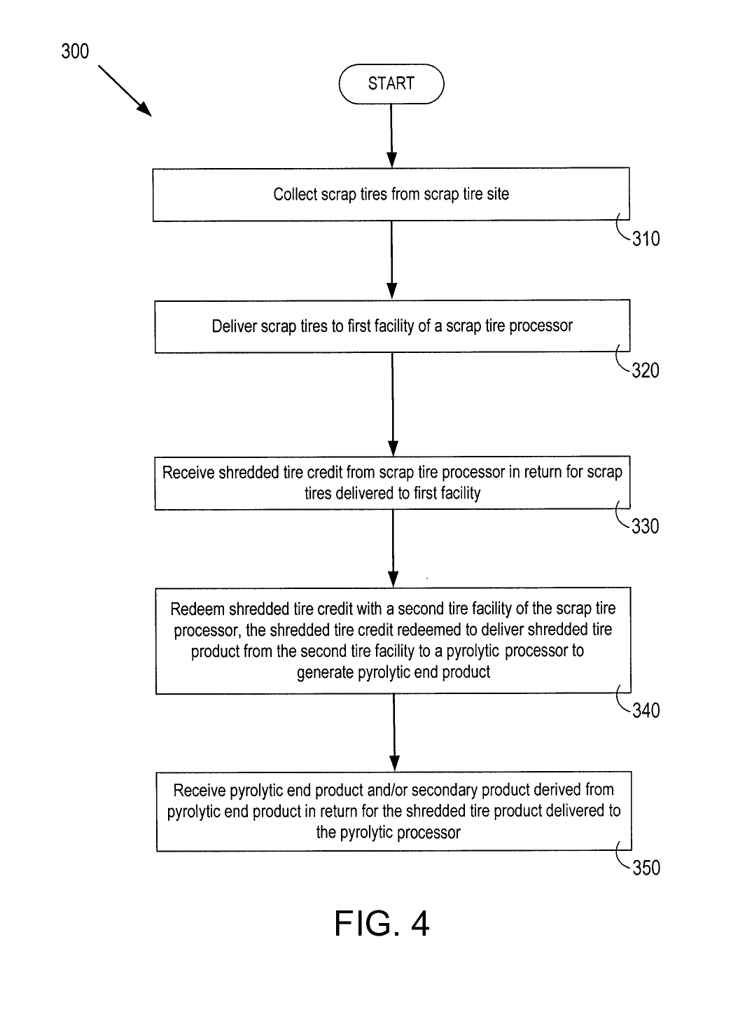

Referring to FIG. 4, steps of an embodiment of a method 300 for recycling tires following principles of the present disclosure are illustrated. Scrap tires are collected from a scrap tire site (step 310). A scrap tire delivery is sent to a scrap tire processor at a first shred facility for conversion into shredded tire product (step 320).

In embodiments, at least one scrap tire can be collected from a site of a scrap tire generator for inclusion in the scrap tire delivery. Portable shear equipment can be used to break down at least one scrap tire at the site of the scrap tire generator for inclusion in the scrap tire delivery. Using the portable shear equipment to break down the scrap tires at the site of the scrap tire generator can reduce shipping costs for transporting the scrap tire delivery from the scrap tire generator to the scrap tire processor at the first shred facility. The scrap tire delivery can include scrap tires which have been reduced in size by the portable shear equipment and transported via truck such that no oversized-load shipping costs are incurred. In other embodiments, the scrap tire delivery can include one or more scrap tires which are removed from the site of the scrap tire generator via truck without being reduced in size. This approach may incur oversized-shipping costs.

A shredded tire credit is received from the scrap tire processor in return for the scrap tire delivery to the first shred facility (step 330). The shredded tire credit is redeemed with the scrap tire processor for an amount of shredded tire product processed at a second shred facility of the scrap tire processor and delivered to a pyrolytic processor to generate at least one pyrolytic end product from the shredded tire product (step 340).

In embodiments, the shredded tire credit can have a value comprising at least one of an amount of shredded tire product and a monetary value. The value of the shredded tire credit can be based upon the size of the scrap tire delivery. The value of the shredded tire credit can be based upon an amount of money received by the scrap tire processor in selling the shredded tire product generated by the scrap tire processor at the first shred facility from the scrap tire delivery.

A pyrolytic processor payment is received from the pyrolytic processor in return for the shredded tire product received from the redeemed shredded tire credit (step 350). The pyrolytic processor payment can include an amount of at least one of: (i) a pyrolytic end product from the shredded tire product and (ii) a secondary product derived from a pyrolytic end product from the shredded tire product.

In embodiments, the pyrolytic processor can be closer to the second shred facility than to the first shred facility. The pyrolytic processor payment can have a value based upon the amount of shredded tire product received by the pyrolytic processor from the redeemed shredded tire credit. The pyrolytic processor payment can include at least one pyrolytic end product which comprises carbon black, oil, and/or pyro-gas. In embodiments, the secondary product of the pyrolytic processor payment can comprise energy generated from equipment powered by a pyro-gas.

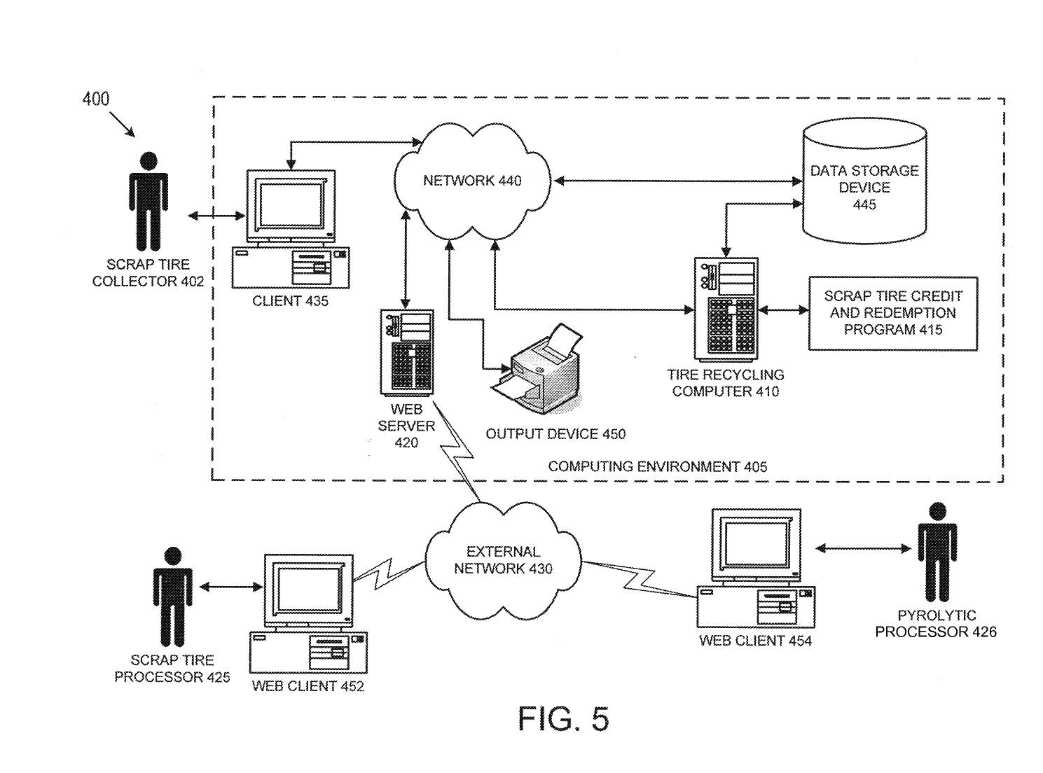

Referring to FIG. 5, an embodiment of a computer-implemented system 400 for recycling tires is shown. A scrap tire collector 402 can operate a computing environment 405 that includes a tire recycling computer 410 operating computer-executable instructions in the form of a scrap tire credit and redemption program 415 stored upon a non-transitory, tangible computer-readable medium. The scrap tire credit and redemption program 415 can include a scrap tire credit module and a credit redemption module. A network-enabled interface, in the form of a web server 420 in the illustrated embodiment, can be operably arranged with the tire recycling computer 410 and is adapted to exchange information with a partner site 425, 426 over a network 430.

The tire recycling computer 410 is adapted to execute the scrap tire credit and redemption program contained on the physical computer-readable medium 415. The scrap tire credit module has computer executable instructions adapted to calculate a value of a shredded tire credit based upon a scrap tire delivery by the scrap tire collector 402 to a first shred facility of a scrap tire processor 425. The credit redemption module has computer executable instructions adapted to generate and send a redemption communication through the network 430 to the scrap tire processor 425 to redeem a selected shredded tire credit held by the scrap tire collector 402. The redemption communication can include information sufficient to indicate: the shredded tire credit being redeemed, an identification of a second shred facility of the scrap tire processor 425 from which a specified quantity of shredded tire product is to be provided, and delivery information for a partner pyrolytic processor 426 to which the shredded tire product is to be delivered.

The computing environment 405 can include a number of computer systems, which generally can include any type of computer system based on: a microprocessor, a mainframe computer, a digital signal processor, a portable computing device, a personal organizer, a device controller, or a computational engine within an appliance. More specifically, the computing environment 405 can include a client 435, an internal network 440, at least one tire recycling computer 410 operating the scrap tire credit and redemption program 415, a data storage device 445, an output device 450, and the web server 420 operatively connected to the external network 430. The client 435, the tire recycling computer 410, the data storage device 445, the output device 450, and the web server 420 are operatively connected together via the internal network 440.

The scrap tire collector 402 is communicatively connected with one or more scrap tire processors 425 and pyrolytic processor 426 through the external network 430, such as the Internet. In embodiments, one or more scrap tire generators can be communicatively connected with the scrap tire collector 402 via the external network 430. In embodiments, the scrap tire credit and redemption program 415 can include instructions adapted to facilitate the scheduling of scrap tire collections from one or more scrap tire generators.

A plurality of web clients 452, 454 can use the computing environment 405 to interface with the scrap tire collector 402 operating the computing environment 405. For example, a scrap tire processor 425 can use the web client 452 to receive information from, and to transmit information to, the scrap tire collector's 402 computing environment 405 about the scrap tire delivery and the shredded tire credit issuing as a result of the scrap tire delivery. In embodiments, the information can include the value of a shredded tire credit based upon a scrap tire delivery by the scrap tire collector 402 to a first shred facility of a scrap tire processor 425, the redemption of a selected shredded tire credit held by the scrap tire collector 402, an identification of a second shred facility of the scrap tire processor 425 from which a specified quantity of shredded tire product is to be provided, and delivery information for a partner pyrolytic processor 426 to which the shredded tire product is to be delivered.

The partner pyrolytic processor 426 can use the web client 454 to transmit information from the web client 454 for use by the scrap tire credit and redemption program 415, such as scheduling information for receiving the shredded tire product form the second shred facility and information concerning a pyrolytic processor payment from the pyrolytic processor 426 in return for receiving the shredded tire product from the redeemed shredded tire credit. In other embodiments a different communication channel can be established between the scrap tire generators, the scrap tire processors, the pyrolytic processors and the scrap tire collector and the scrap tire credit and redemption program 415.

The client 435 can be adapted to communicate with the scrap tire credit and redemption program 415 through the internal network 440. The client 435 can be used to host a utility interface in the form of a graphical user interface of the scrap tire credit and redemption program 415. The graphical user interface can be adapted to facilitate the input of information into the program 415 and the display of outputs from the program 415.

In embodiments, the client 435 can be used to communicate with an authorized user associated with the scrap tire collector 402 to enter scrap tire collection, shredded tire credit, and pyrolytic payment data into the data storage device 445, and/or to execute the scrap tire credit and redemption program 415. The client 435 can comprise at least one input device. The client 435 can generally include any node on a network including computational capability and including a mechanism for communicating across the network 440.

In one embodiment, the client 154 hosts an application front end of the scrap tire credit and redemption program 415. The application front end can generally include any component of the scrap tire credit and redemption program 415 that can receive input from the user 402 or the client 435, communicate the input to the scrap tire credit and redemption program 415, receive output from the scrap tire credit and redemption program 415, and present the output to the user 402 or the client 435. In one embodiment, the application front end can be a stand-alone system.

The network 440 can generally include any type of wired or wireless communication channel capable of coupling together computing nodes. Examples of a suitable network 440 include, but are not limited to, a local area network, a wide area network, or a combination of networks.

The tire recycling computer 410 can generally include any computational node including a mechanism for servicing requests from a client for computational resources, data storage resources, or a combination of computational and data storage resources. Furthermore, the tire recycling computer 410 can generally include any system that can host the scrap tire credit and redemption program 415. The tire recycling computer 410 can generally include any component of an application that can receive input from the web clients 452, 454 via the web server 420 and the client 435, process the input, and present the output to the scrap tire credit and redemption program 415, the web server 420, and/or the data storage device 445. The tire recycling computer 410 can generally include any component of an application that can process data, interact with the data storage device 445, and execute logic for the scrap tire credit and redemption program 415. The tire recycling computer 410 may be implemented in one or more electronic devices that are located in one or more locations.

The scrap tire credit and redemption program 415 comprises a computer program product residing on a non-transitory, tangible computer readable medium having a scrap tire credit module and a credit redemption module. The scrap tire credit and redemption program 415 contains computer executable instructions adapted to exchange information in the form of data with the data storage device 445. The program 415 can include a graphical user interface which can facilitate the input of data into the program 415. In embodiments, the scrap tire credit and redemption program 415 includes a plurality of instructions stored thereon which, when executed by the tire recycling computer 410, cause the computer 410 to perform steps associated with a method for tire recycling following principles of the present disclosure.

In embodiments, the scrap tire credit module can have computer executable instructions adapted to calculate a value of a shredded tire credit based upon a scrap tire delivery by the scrap tire collector 402 to a first shred facility of a scrap tire processor 425. In embodiments, the scrap tire credit module has computer executable instructions adapted to calculate the value of the shredded tire credit based upon at least one of the size of the scrap tire delivery and an amount of money received by the scrap tire processor 425 in selling the shredded tire product generated by the scrap tire processor 425 from the scrap tire delivery.

The credit redemption module can have computer executable instructions adapted to generate and send a redemption communication through the network 430 to the scrap tire processor 425 to redeem a selected shredded tire credit held by the scrap tire collector 402. The redemption communication can include information sufficient to indicate: the shredded tire credit being redeemed, an identification of a second shred facility of the scrap tire processor 425 from which a specified quantity of shredded tire product is to be provided, and delivery information for a partner pyrolytic processor 426 to which the shredded tire product is to be delivered.

In embodiments, the scrap tire credit and redemption program 415 can include a pyrolytic processor payment module having computer executable instructions adapted to calculate an amount of a pyrolytic processor payment from the partner pyrolytic processor 426 to the scrap tire collector 402 in return for the shredded tire product received by the pyrolytic processor 426 from the redeemed shredded tire credit. In embodiments, the pyrolytic processor payment module has computer executable instructions adapted to calculate the amount of the pyrolytic processor payment based upon the amount of shredded tire product received by the pyrolytic processor 426 from the redeemed shredded tire credit.

In embodiments, the scrap tire credit and redemption program 415 can include a reconciliation module adapted to reconcile a pyrolytic processor payment with the redeemed shredded tire credit. The reconciliation module can be adapted to verify that the payment corresponds to the value of the shredded tire credit and to track payment for the redeemed shredded tire credit.

In embodiments, the scrap tire credit and redemption program 415 can include a plurality of instructions which, when executed by the tire recycling computer 410, cause the computer 410 to perform steps associated with tire recycling using a shredded tire credit and redemption technique as described herein. In embodiments, the scrap tire credit and redemption program 415 contains computer executable instructions for tire recycling, including steps in the methods shown and described in FIGS. 2 and 3, for example.

The scrap tire credit and redemption program 415 can also contain a report engine, which can be provided to generate displays of information stored in the data storage device 445 concerning shredded tire credit and pyrolytic processor payment data, which can be viewed using the output device 450 or the computer 410, for example. A report engine can be provided to generate displays of information stored in the data storage device 445 concerning the shredded tire credits and pyrolytic processor payments, which can be viewed using the output device 450, for example. In one embodiment, the report engine further provides pre-configured and/or ad hoc reports relating to the scrap tire collector's 402 shredded tire credits and pyrolytic processor payments.

Any suitable computer-readable storage medium can be utilized, including, for example, hard drives, floppy disks, CD-ROM drives, tape drives, zip drives, flash drives, optical storage devices, magnetic storage devices, and the like. The client 435 can be used by an authorized user 402 to help administer the scrap tire credit and redemption program 415.

The database or data storage device 445 can generally include any type of system for storing data in non-volatile storage. This includes, but is not limited to, systems based upon: magnetic, optical, and magneto-optical storage devices, as well as storage devices based on flash memory and/or battery-backed up memory. In one embodiment, the database 445 contains information which can be used by the scrap tire credit and redemption program 415 to perform its intended functionality and to store outputs generated by the scrap tire credit and redemption program 415. The data storage device 445 can contain a permission database which stores user credentials and permissions specific to each user of the scrap tire collector 402, the scrap tire processor 425, and the pyrolytic processor 426, for example.

The output device 450 can comprise a printer, a display monitor, and a connection to another device, for example. The output device 450 can be used to generate reports for sending to the investment product owner which contain information generated by the scrap tire credit and redemption program 415. The output device 450 can be used to communicate to the user 402 information which is generated by the scrap tire credit and redemption program 415.

The web server 420 can provide a suitable web site or other Internet-based graphical user interface which is accessible by the scrap tire processor 425, the pyrolytic processor 426 and a scrap tire generator, for example. The web clients 452, 454 can be connected to the web server 420 through the network connection 430 (e.g., Internet, Intranet, LAN, WAN and the like). The web server 420 can use an authentication server in order to validate and assign proper permissions to authorized users of the system. A permission database can store web user credentials and permissions specific to each user. The web server 420 can be outfitted with a firewall such that requests originating from outside the computing environment 405 pass through the firewall before being received and processed at the web server 420. In some embodiments, the web server 420 can be adapted to host a web site, to execute enterprise applications, to deliver web pages and other content upon request to clients 435, 452, 454 and to receive content from clients 435, 452, 454.

In addition to the components discussed above, the computing environment 405 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

In embodiments, a method for recycling tires following principles of the present disclosure can include employing a computer processor to execute computer-executable instructions of a scrap tire credit and redemption program stored on a physical computer-readable medium. The computer-executable instructions can perform steps related to calculating and redeeming a shredded tire credit. A value of a shredded tire credit can be calculated based upon a scrap tire delivery by a scrap tire collector to a first shred facility of a scrap tire processor. A redemption communication can be generated which includes information sufficient to indicate: the shredded tire credit being redeemed, an identification of the second shred facility of the scrap tire processor from which a specified quantity of shredded tire product is to be provided, and delivery information for a partner pyrolytic processor to which the shredded tire product is to be delivered. The redemption communication can be transmitted through a network including a web-enabled interface to a scrap tire processor.

The value of the shredded tire credit can be calculated based upon at least one of the sizes of scrap tire delivery and an amount of money received by the scrap tire processor in selling the shredded tire product generated by the scrap tire processor from the scrap tire delivery.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for recycling tires comprising:
sending a scrap tire delivery to a scrap tire processor at a first shred facility for conversion into shredded tire product;
receiving a shredded tire credit from the scrap tire processor in return for the scrap tire delivery;
redeeming the shredded tire credit with the scrap tire processor for an amount of shredded tire product processed at a second shred facility of the scrap tire processor and delivered to a pyrolytic processor to generate at least one pyrolytic end product from the shredded tire product;
receiving a pyrolytic processor payment from the pyrolytic processor in return for the shredded tire product received from the redeemed shredded tire credit, the pyrolytic processor payment including an amount of at least one of: (i) a pyrolytic end product from the shredded tire product and (ii) a secondary product derived from a pyrolytic end product from the shredded tire product.

2. The method for recycling tires according to claim 1, further comprising:
collecting at least one scrap tire from a site of a scrap tire generator for inclusion in the scrap tire delivery.

3. The method for recycling tires according to claim 2, further comprising:
using portable shear equipment to break down at least one scrap tire at the site of the scrap tire generator for inclusion in the scrap tire delivery.

4. The method for recycling tires according to claim 1, wherein the shredded tire credit has a value comprising at least one of an amount of shredded tire product and a monetary value.

5. The method for recycling tires according to claim 4, wherein the value of the shredded tire credit is based upon the size of the scrap tire delivery.

6. The method for recycling tires according to claim 4, wherein the value of the shredded tire credit is based upon an amount of money received by the scrap tire processor in selling the shredded tire product generated by the scrap tire processor from the scrap tire delivery.

7. The method for recycling tires according to claim 1, wherein the pyrolytic processor is closer to the second shred facility than to the first shred facility.

8. The method for recycling tires according to claim 1, wherein the pyrolytic processor payment has a value based upon the amount of shredded tire product received by the pyrolytic processor from the redeemed shredded tire credit.

9. The method for recycling tires according to claim 1, wherein the pyrolytic processor payment includes at least one pyrolytic end product comprising carbon black, oil, and pyro-gas.

10. The method for recycling tires according to claim 1, wherein the secondary product of the pyrolytic processor payment comprises energy generated from equipment powered by a pyro-gas.

11. A system for recycling tires comprising:
a physical computer-readable medium having computer-executable instructions stored thereon, the computer-executable instructions comprising a scrap tire credit and redemption program including a scrap tire credit module and a credit redemption module;
a computer processor adapted to execute the scrap tire credit and redemption program contained on the physical computer-readable medium; and
a network-enabled interface operably arranged with the computer processor, the network-enabled interface adapted to exchange information with a partner site over a network;
wherein the scrap tire credit module has computer executable instructions adapted to calculate a value of a shredded tire credit based upon a scrap tire delivery by a scrap tire collector to a first shred facility of a scrap tire processor; and
wherein the credit redemption module has computer executable instructions adapted to generate and send a redemption communication through the network to the scrap tire processor to redeem a selected shredded tire credit held by the scrap tire collector, the redemption communication including information sufficient to indicate: the shredded tire credit being redeemed, an identification of a second shred facility of the scrap tire processor from which a specified quantity of shredded tire product is to be provided, and delivery information for a partner pyrolytic processor to which the shredded tire product is to be delivered.

12. The system for recycling tires according to claim 11, wherein the scrap tire credit module has computer executable instructions adapted to calculate the value of the shredded tire credit based upon at least one of the size of the scrap tire delivery and an amount of money received by the scrap tire processor in selling the shredded tire product generated by the scrap tire processor from the scrap tire delivery.

13. The system for recycling tires according to claim 11, wherein the scrap tire credit and redemption program includes a pyrolytic processor payment module having computer executable instructions adapted to calculate an amount of a pyrolytic processor payment from the partner pyrolytic processor to the scrap tire collector in return for the shredded tire product received by the pyrolytic processor from the redeemed shredded tire credit.

14. The system for recycling tires according to claim 13, wherein the pyrolytic processor payment module has computer executable instructions adapted to calculate the amount of the pyrolytic processor payment based upon the amount of shredded tire product received by the pyrolytic processor from the redeemed shredded tire credit.

15. The system for recycling tires according to claim 11, further comprising:
a delivery system adapted to make the scrap tire delivery to the first shred facility of the scrap tire processor.

16. A method for recycling tires comprising:
employing a computer processor to execute computer-executable instructions of a scrap tire credit and redemption program stored on a physical computer-readable medium, the computer-executable instructions performing steps comprising:
calculating a value of a shredded tire credit based upon a scrap tire delivery by a scrap tire collector to a first shred facility of a scrap tire processor, and
generating a redemption communication including information sufficient to indicate: the shredded tire credit being redeemed, an identification of a second shred facility of the scrap tire processor from which a specified quantity of shredded tire product is to be provided, and delivery information for a partner pyrolytic processor to which the shredded tire product is to be delivered;
transmitting the redemption communication through a network including a web-enabled interface to the scrap tire processor.

17. The method for recycling tires according to claim 16, wherein the value of the shredded tire credit is calculated based upon at least one of the size of the scrap tire delivery and an amount of money received by the scrap tire processor in selling the shredded tire product generated by the scrap tire processor from the scrap tire delivery.

18. The method for recycling tires according to claim 16, wherein the scrap tire credit and redemption program includes computer-executable instructions performing the following step:
storing the value of the shredded tire credit in a data storage device operably arranged with the computer processor.

19. The method for recycling tires according to claim 16, wherein the scrap tire credit and redemption program includes computer-executable instructions performing the following step:
calculating an amount of a pyrolytic processor payment in return for the shredded tire product received by the pyrolytic processor.

20. The method for recycling tires according to claim 19, wherein the pyrolytic processor payment is calculated based upon the amount of shredded tire product received by the pyrolytic processor from the redeemed shredded tire credit.
